(19) United States
(12) Patent Application Publication
(10) Pub. No.: US 2019/0132632 A1
(43) Pub. Date: May 2, 2019

(54) Cloud DVR Storage Reduction

(71) Applicant: Cisco Technology, Inc., San Jose, CA (US)

(72) Inventors: Ian John Bastable, Fareham (GB); Charles Thomas Cartwright, Bassett (GB)

(73) Assignee: Cisco Technology, Inc., San Jose, CA (US)

(21) Appl. No.: 15/879,562

(22) Filed: Jan. 25, 2018

Related U.S. Application Data
(60) Provisional application No. 62/578,007, filed on Oct. 27, 2017.

(51) Int. Cl. H04N 21/4147; H04N 5/76; H04N 21/43

(52) U.S. Cl. CPC H04N 21/4147; H04L 67/1097; H04N 21/43; H04N 5/76

(57) ABSTRACT

Cloud Digital Video Recorder (cDVR) storage reduction may be provided. First, a plurality of recording requests to record a content program may be received. Then a plurality of content data instances corresponding to the content program may be recorded by recording a content data instance for each of the plurality of recording requests. Next, a plurality of play-back requests corresponding to the content program may be received. Ones of the plurality of content data instances may be respectively provided in response to each of the plurality of play-back requests and then the ones of the plurality of content data instances may be respectively deleted in response to providing respectively the ones of the plurality of content data instance. In addition, other ones of the plurality of content data instances may be periodically deleted.

### RELATED APPLICATION

Under provisions of 35 U.S.C. § 119(e), Applicant claims the benefit of U.S. Provisional Application No. 62/578,007 filed Oct. 27, 2017, which is incorporated herein by reference.

### BACKGROUND

Cloud computing is a model that allows access to a shared pool of configurable computing resources. Cloud computing and storage solutions provide users and enterprises with various capabilities to store and process their data in third-party data centers. It shares resources to achieve coherence and economies of scale.

Cloud computing also focuses on maximizing the effectiveness of the shared resources. Cloud resources are usually not only shared by multiple users, but are also dynamically reallocated per demand. This can work for allocating resources to users. For example, a cloud computer facility that serves European users during European business hours with a specific application (e.g., e-mail) may reallocate the same resources to serve North American users during North American business hours with a different application (e.g., a web server). This approach helps maximize computing power use while reducing the overall resources cost by using, for example, less power, air conditioning, rack space, to maintain the system.

### BRIEF DESCRIPTION OF THE DRAWINGS

The accompanying drawings, which are incorporated in and constitute a part of this disclosure, illustrate various embodiments of the present disclosure. In the drawings:

FIG. 1 shows an operating environment;

FIG. 2 shows an operating environment;

FIG. 3 shows a data plane;

FIG. 4 is a flow chart of a method for providing Cloud Digital Video Recorder (cDVR) storage reduction; and

FIG. 5 shows a computing device.

### DETAILED DESCRIPTION

### Overview

Cloud Digital Video Recorder (cDVR) storage reduction may be provided. First, a plurality of recording requests to record a content program may be received. Then a plurality of content program data instances corresponding to the content program may be recorded by recording a content data instance for each of the plurality of recording requests. For example, the content program may comprise a linear television (TV) content program or a content program presented at a given time. Next, and spread out over time, a plurality of play-back requests corresponding to the content program may be received. Ones of the plurality of content data instances may be respectively provided in response to each of the plurality of play-back requests and then the ones of the plurality of content data instances may be respectively deleted in response to providing respectively the ones of the plurality of content data instance. In addition, other ones of the plurality of content data instances may be periodically deleted.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A digital video recorder (DVR) may comprise a consumer electronics device or application software that records video in a digital format to, for example, a disk drive. Network DVR (nDVR), or network personal video recorder (nPVR), or remote storage digital video recorder (RS-DVR) is a network-based digital video recorder (DVR) stored at a service provider's central location (or distributed cloud locations) rather than at the consumer's private home. Conventionally, media content was stored in a subscriber's set-top box hard drive, but with nDVR, the service provider may utilize a large number of servers, on which the subscribers' media content may be stored.

RS-DVR refers to a service where a subscriber can record a program and store it on the network. A stored program may only be available to a person who recorded it. Should any two persons record the same program, the copies may be recorded and stored as separate copies for legal reasons. Essentially implementing a traditional DVR with network based storage, cloud computing services may include RS-DVR services. Cloud RS-DVR services may comprise a solution to emulate a user's DVR in the cloud. By enabling recording in the cloud, recorded content may be accessed from a number of devices at any time. Embodiments of the disclosure may provide a unique copy of a content program per user in a network based storage. When multiple users want to record the same program on an nDVR, duplicate copies of the same content data may be stored (e.g., one copy for each requesting user) in order to satisfy some legal requirement, for example, “fair use”.

In nPVR, also know commercially as Cloud DVR (cDVR), recordings of linear TV content may be made at real time of broadcast. (There may be real-time constraints placed on the latency of the recording process.) Furthermore, for each user that has requested the recording be carried out on behalf of, a distinct copy of the recorded content may be written to mass storage for later retrieval at play-back time. This is known as “private-copy” or variations thereof.

The mass storage capacity that may be required for recordings in a private-copy environment may be large given that a distinct copy may be made for each user. For example, 100 hours of recordings at 16 Mbps may require approximately 600 GB per user. For 1 million users, this may become 600 PB (six hundred peta-bytes). Accordingly, private-copy storage system may be costly due to the amount of mass storage that may be required. Consequently, optimizations consistent with embodiments of the present disclosure may reduce this cost in mass storage for private-copy.

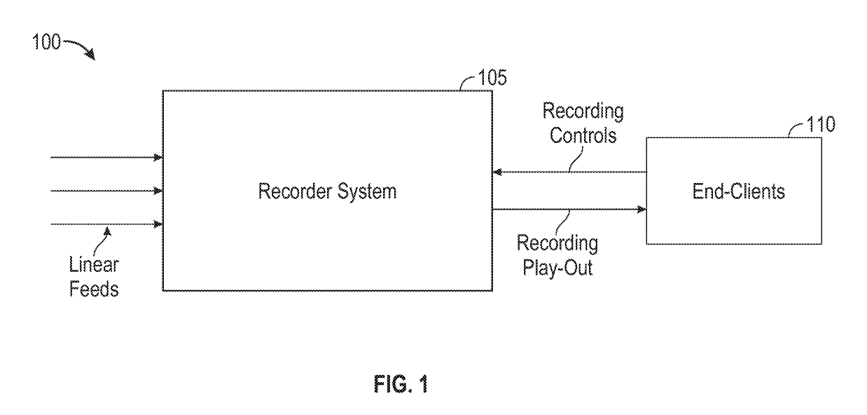

FIG. 1 is a block diagram of an operating environment 100. As shown in FIG. 1, operating environment 100 may include a recorder system 105 and end-clients 110. Recorder system 105 may receive a plurality of linear feeds. Content received from the plurality of linear feeds may be processed per recording controls received from end-clients 110 and recorder system 105 may record and provide recording play-back (i.e., play-out) to end-clients 110. The plurality of linear feeds may comprise, but are not limited to, linear television channels.

Recorder system 105 may receive recording controls from end-clients 110 and provide recording play-back to end-clients 110 over a network. The instructions to record (e.g., recording controls) may come from devices other than the user and/or end-clients 110. Moreover, the device sending the recording request and the device consuming the recording may not be the same. The network may comprise any type of network (e.g., the Internet, a hybrid fiber-coaxial (HFC) network, a content delivery network (CDN), etc.) capable of facilitating control and play-back. Furthermore, recorder system 105 may receive the plurality of linear feeds in any way including receiving the plurality of linear feeds over any type of network.

Any device within end-clients 110 may comprise, but is not limited to, a connected TV, a set-top box, a digital video recorder, a cable modem, a personal computer, a Wi-Fi access point, a cellular base station, a switch servicing multiple clients in a vicinity, a tablet device, a mobile device, a smart phone, a telephone, a remote control device, a network computer, a mainframe, a router, or other similar microcomputer-based device. End-clients 110 may comprise any type devices capable of sending recording controls to recorder system 105 and receiving recording play-back from recorder system 105 in response.

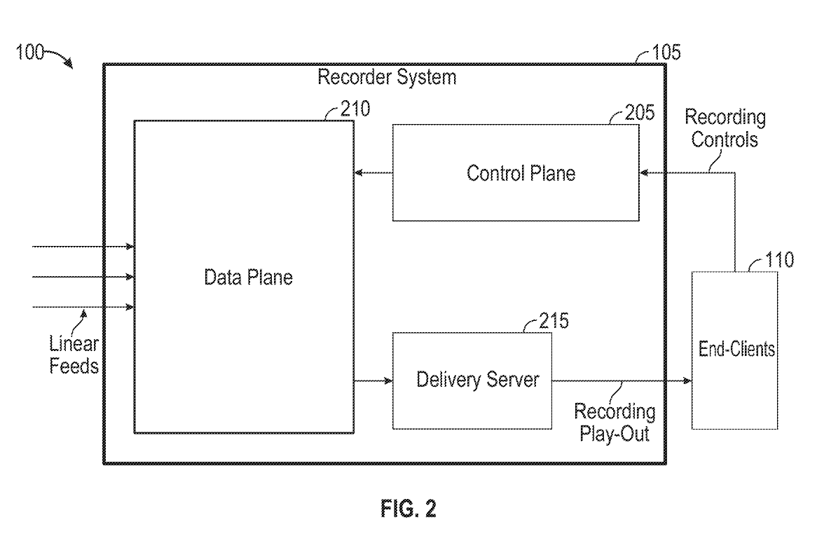

FIG. 2 is a block diagram showing operating environment 100 in greater detail. As shown in FIG. 2, recorder system 105 may comprise a control plane 205, a data plane 210, and a delivery server 215. Control plane 205 may interact with the users (e.g., through end-clients 110) to obtain recording commands (e.g., recording controls) and may schedule and manage recorder resources to be allocated for the recording defined by the users. Data plane 210 may then record ones of the linear feeds according to the schedule and under the management of control plane 205. Delivery server 215 may play-out ones of the recorded content from data plane 210 to end-clients 110 (e.g., recording play-out).

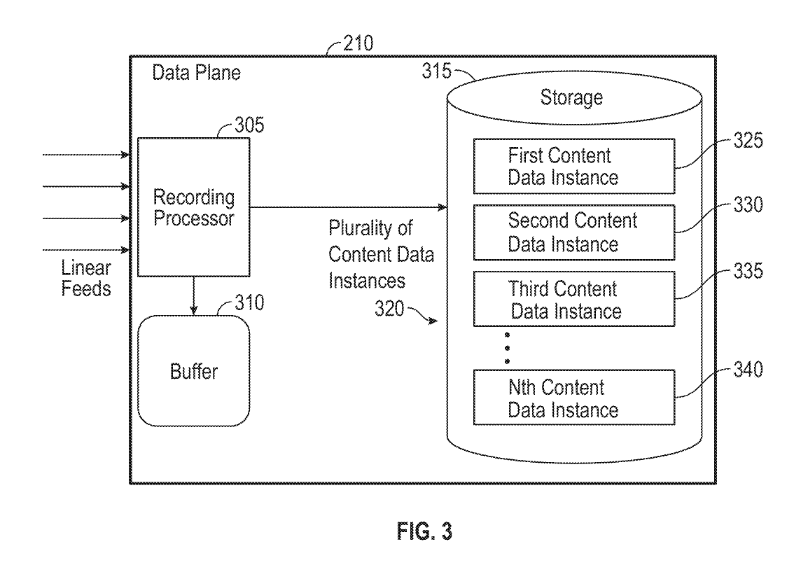

FIG. 3 is a block diagram showing data plane 210 in greater detail. As shown in FIG. 3, data plane 210 may comprise a recording processor 305, a buffer 310, and a storage 315. Recording processor 305 may receive content from ones of the plurality of linear feeds. The plurality of linear feeds may comprise, but are not limited to, linear television channels. Content from ones of the plurality of linear feeds may be temporarily saved in buffer 310 by recording processor 305. Recording processor 305 may be configured to record each of the plurality of linear feeds for a finite sliding time-window into buffer 310. Data in buffer 310 may not be exposed to users (e.g., through end-clients 110) and there may be no direct way for end-clients 110 to consume any content from buffer 310. From buffer 310, recording processor 305 may write multiple copies of the content data to storage 315 as a plurality of content data instances 320.

Recording processor 305 may store plurality of content data instances 320 (e.g., a first content data instance 325, a second content data instance 330, a third content data instance 335, up to an Nth content data instance 340) in storage 315 on a per user basis. In other words, recording processor 305 may store a number of content data instances that may be equal to the number of requests for the content received from the users. For example, if N requests are received, then N content data instance may be stored. Content data instances may not be pre-assign to users at record time, but may be assigned latter (i.e., late binding). System 100 may support any number of requests and content copies up to Nth content data instance 340 that may correspond to an Nth request for the content. Each one of plurality of content data instances 320 may comprise the same content data.

Although each of the plurality of content data instances 320 may be recorded in response to respective and corresponding ones of the plurality of recording requests to record the content program, ones of the plurality of content data instances 320 may not be bound to a particular user until play-back time (i.e., late binding). In other words, recording processor 305 may create an inventory of content data instances (i.e., plurality of content data instances 320). While the number of instances (e.g., N) may equal the number of the plurality of recording requests, individual ones in the inventory may not be assigned to a requesting user until play-back time.

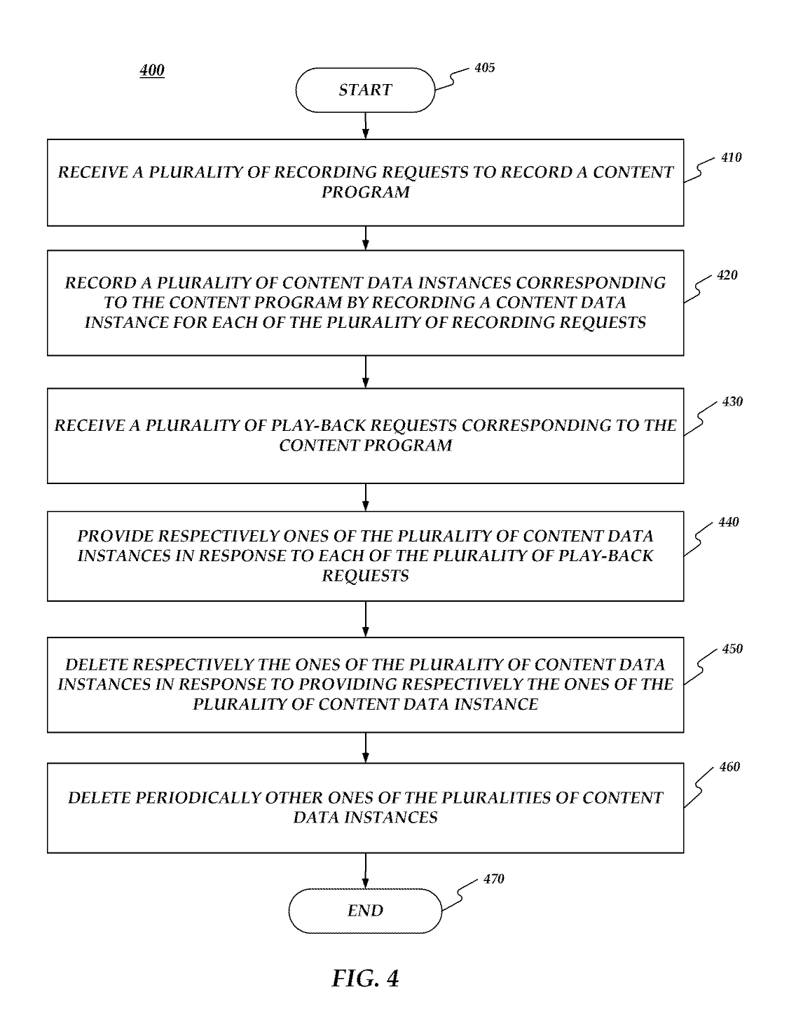

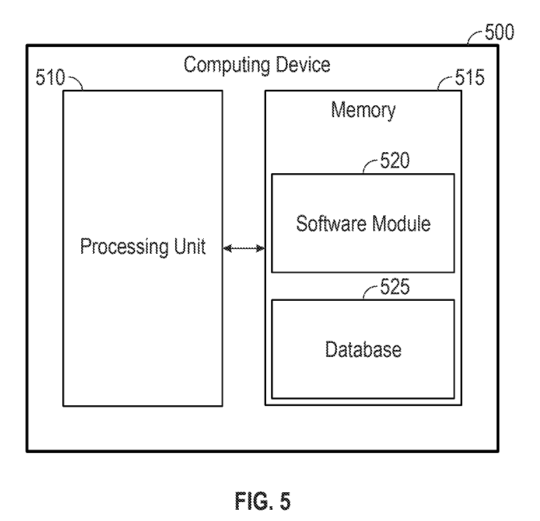

FIG. 4 is a flow chart setting forth the general stages involved in a method 400 consistent with an embodiment of the disclosure for providing cDVR storage reduction. Method 400 may be implemented using recording processor 305. A computing device 500, as described in more detail below with respect to FIG. 5, may provide an operating environment for recording processor 305, for example. Ways to implement the stages of method 400 will be described in greater detail below.

Method 400 may begin at starting block 405 and proceed to stage 410 where recording processor 305 may receive a plurality of recording requests to record a content program. For example, each user may make an explicit or implicit request prior to content delivery time that they wish a recording of the content program to be carried out on their behalf.

From stage 410, where recording processor 305 receives the plurality of recording requests to record the content program, method 400 may advance to stage 420 where recording processor 305 may record plurality of content data instances 320 corresponding to the content program, one for each of the plurality of recording requests. For example, at recording time, the content data corresponding to the content program may be captured by recording processor 305 from a source (e.g., linear feeds) and recording processor 305 may then write a number of copies (i.e., N copies) equal to the number of users that have requested the recording. Recording processor 305 may make this number of copies of the content program and write them to storage 315 as plurality of content data instances 320.

Once recording processor 305 records plurality of content data instances 320 corresponding to the content program by recording a content data instance for each of the plurality of recording requests in stage 420, method 400 may continue to stage 430 where recording processor 305 may receive a plurality of play-back requests corresponding to the content program. Ones of the plurality of play-back requests may be received over a period of time and at times the users wish to receive their recordings. Although each of the plurality of content data instances 320 may be recorded in response to respective and corresponding ones of the plurality of recording requests to record the content program, ones of the plurality of content data instances 320 may not be bound to a particular user until play-back time (i.e., late binding).

After recording processor 305 receive the plurality of play-back requests corresponding to the content program in stage 430, method 400 may proceed to stage 440 where recording processor 305 may provide respectively ones of the plurality of content data instances in response to each of the plurality of play-back requests. For example, at play-back time, a copy of the content (i.e., content data instance) residing on storage 315 may be assigned to the specific user and retrieved for the user and returned to the user at the user's end-client for rendering. Each user may receive a distinct copy of the content (i.e., content data instance) that has not been used before. In this way, each user may make their individual distinct recording and play back their individual distinct recording. No user may access another user's copy of the recording, or any copy seeded from another users copy.

Once recording processor 305 provides respectively ones of the plurality of content data instances in response to each of the plurality of play-back requests in stage 440, method 400 may continue to stage 450 where recording processor 305 may delete respectively the ones of the plurality of content data instances in response to providing respectively the ones of the plurality of content data instance. For example, once a one of the plurality content data instances is provided (i.e., played-back) to a requesting user, this one of the plurality content data instances may be deleted from storage 315 thus freeing space on storage 315.

After or in parallel with recording processor 305 deleting respectively the ones of the plurality of content data instances in response to providing respectively the ones of the plurality of content data instance in stage 450, method 400 may proceed to stage 460 where recording processor 305 may delete periodically other ones of the plurality of content data instances 320. For example, at the instant of recording time, each user may have a copy of the content written to storage 315 on their behalf. Over time, however, the probability of any individual user requesting access to their recorded content diminishes. This information can be used by recording processor 305 to discard copies (i.e., instances) of the recorded content over the life cycle of the recording, thus reducing the total mass storage capacity needed for storage 315.

In order to reduce the total mass storage capacity of storage 315, the number of distinct copies of recordings retained by storage 315 in plurality of content data instances 320 may be reduced. Accordingly, embodiments of the disclosure may include a discarding process for when to discard and how many to discard of other ones of the plurality of content data instances 320. Such a discarding process may be parameterized with variables such as record time, record source, content type (e.g., football, golf, drama), user type, weather, location (e.g., U.K., France), etc. These parameters might, or might not, be passed to recording processor 305 at record time, or might be internally derived by recording processor 305 by observing user play-back request behavior or other external data sources.

The discarding process may be based on time since recording and a decay (e.g., log-base-2) probability of viewing. For example, N users make a 1 hour recording on a particular day. The storage capacity in this example may be N hours on day zero, the day of the recording. Now further consider that the probability that a user will ever access their recording reduces each day so the number of needed content data instances may follow a predetermined decay curve. In other words, the mass storage capacity to fulfill successful nPVR play-back may be reduced as the play-back probability tends towards a predetermined decay curve. Accordingly, recording processor 305 may delete periodically other ones of the plurality of content data instances 320 to provide, for example, cDVR storage reduction.

Embodiments of the disclosure may ensure that sufficient copies of the recorded content are retained to fulfill any play-back requests from a distinct copy of the recording. However, should insufficient copies remain (i.e., meaning that at play-back time, all remaining copies in storage 315 have been allocated to other users), then the user, and any subsequent users, may be refused play-back. Once recording processor 305 deletes periodically other ones of the plurality of content data instances in stage 460, method 400 may then end at stage 470. Consistent with embodiments of the disclosure, stages 430, 440, and 450 maybe performed in parallel with stage 460 and these stages may be repeated before reaching stage 470.

FIG. 5 shows computing device 500 in more detail. As shown in FIG. 5, computing device 500 may include a processing unit 510 and a memory unit 515. Memory unit 515 may include a software module 520 and a database 525. While executing on processing unit 510, software module 520 may perform processes for providing cDVR storage reduction, including for example, any one or more of the stages from method 400 described above with respect to FIG. 4. Computing device 500, for example, may provide an operating environment for recording processor 305, elements comprising recorder system 105, or any one of end-clients 110. Recording processor 305, elements comprising recorder system 105, or any one of end-clients 110 may operate in other environments and are not limited to computing device 500.

Computing device 500 (“the processor”) may be implemented using a Wireless Fidelity (Wi-Fi) access point, a cellular base station, a tablet device, a mobile device, a smart phone, a telephone, a remote control device, a set-top box, a digital video recorder, a cable modem, a personal computer, a network computer, a mainframe, a router, a smart TV-like device, a network storage device, a network relay devices, or other similar microcomputer-based device. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Moreover, the semantic data consistent with embodiments of the disclosure may be analyzed without being stored. In this case, in-line data mining techniques may be used as data traffic passes through, for example, a caching server or network router. Further, the disclosed methods' stages may be modified in any manner, including by reordering stages and/or inserting or deleting stages, without departing from the disclosure.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving a plurality of recording requests to record a content program;
recording a plurality of content data instances corresponding to the content program by recording a content data instance for each of the plurality of recording requests;
receiving a plurality of play-back requests corresponding to the content program;
providing respectively ones of the plurality of content data instances in response to each of the plurality of play-back requests;
deleting respectively the ones of the plurality of content data instances in response to providing respectively the ones of the plurality of content data instance; and
deleting periodically other ones of the plurality of content data instances.

2. The method of claim 1, wherein receiving the plurality of recording requests to record the content program comprises receiving the plurality of recording requests from respective corresponding users wishing a recording of the content program to be carried out on their behalf.

3. The method of claim 1, wherein providing respectively the ones of the plurality of content data instances in response to each of the plurality of play-back requests comprises not binding the ones of the plurality of content data instances to respective corresponding users until respective corresponding ones of the plurality of play-back requests are received.

4. The method of claim 1, wherein providing respectively the ones of the plurality of content data instances in response to each of the plurality of play-back requests comprises providing the ones of the plurality of content data instances not used before and allowing access only to the respective corresponding users to which it was provided.

5. The method of claim 1, wherein deleting periodically the other ones of the plurality of content data instances comprises deleting periodically the other ones of the plurality of content data instances based on parameters comprising at least one of the following: a record time, a record source, a content type, a user type, weather, and a location.

6. The method of claim 1, wherein deleting periodically the other ones of the plurality of content data instances comprises deleting periodically the other ones of the plurality of content data instances based on a play-back probability tending towards a predetermined decay curve.

7. The method of claim 1, further comprising refusing play-back requests when an insufficient number of copies remain in the plurality of content data instances.

8. A system comprising:
a memory storage; and
a processing unit coupled to the memory storage, wherein the processing unit is operative to:
receive a plurality of recording requests to record a content program;
record a plurality of content data instances corresponding to the
content program by recording a content data instance for each of the plurality of recording requests;
receive a plurality of play-back requests corresponding to the content program;
provide respectively ones of the plurality of content data instances in response to each of the plurality of play-back requests;
delete respectively the ones of the plurality of content data instances in
response to providing respectively the ones of the plurality of content data instance; and
delete periodically other ones of the plurality of content data instances.

9. The system of claim 8, wherein the processing unit being operative to receive the plurality of recording requests to record the content program comprises the processing unit being operative to receive the plurality of recording requests from respective corresponding users wishing a recording of the content program to be carried out on their behalf.

10. The system of claim 8, wherein the processing unit being operative to provide respectively the ones of the plurality of content data instances in response to each of the plurality of play-back requests comprises the processing unit being operative to not bind the ones of the plurality of content data instances to respective corresponding users until respective corresponding ones of the plurality of play-back requests are received.

11. The system of claim 8, wherein the processing unit being operative to provide respectively the ones of the plurality of content data instances in response to each of the plurality of play-back requests comprises the processing unit being operative to provide the ones of the plurality of content data instances not used before and allowing access only to the respective corresponding users to which it was provided.

12. The system of claim 8, wherein the processing unit being operative to delete periodically the other ones of the plurality of content data instances comprises the processing unit being operative to delete periodically the other ones of the plurality of content data instances based on parameters comprising at least one of the following: a record time, a record source, a content type, a user type, weather, and a location.

13. The system of claim 8, wherein the processing unit being operative to delete periodically the other ones of the plurality of content data instances comprises the processing unit being operative to delete periodically the other ones of the plurality of content data instances based on a play-back probability tending towards a predetermined decay curve.

14. A computer-readable medium that stores a set of instructions which when executed perform a method executed by the set of instructions comprising:
receiving a plurality of recording requests to record a content program;
recording a plurality of content data instances corresponding to the content program by recording a content data instance for each of the plurality of recording requests;
receiving a plurality of play-back requests corresponding to the content program;
providing respectively ones of the plurality of content data instances in response to each of the plurality of play-back requests;
deleting respectively the ones of the plurality of content data instances in response to providing respectively the ones of the plurality of content data instance; and
deleting periodically other ones of the plurality of content data instances.

15. The computer-readable medium of claim 14, wherein receiving the plurality of recording requests to record the content program comprises receiving the plurality of recording requests from respective corresponding users wishing a recording of the content program to be carried out on their behalf.

16. The computer-readable medium of claim 14, wherein providing respectively the ones of the plurality of content data instances in response to each of the plurality of play-back requests comprises not binding the ones of the plurality of content data instances to respective corresponding users until respective corresponding ones of the plurality of play-back requests are received.

17. The computer-readable medium of claim 14, wherein providing respectively the ones of the plurality of content data instances in response to each of the plurality of play-back requests comprises providing the ones of the plurality of content data instances not used before and allowing access only to the respective corresponding users to which it was provided.

18. The computer-readable medium of claim 14, wherein deleting periodically the other ones of the plurality of content data instances comprises deleting periodically the other ones of the plurality of content data instances based on parameters comprising at least one of the following: a record time, a record source, a content type, a user type, weather, and a location.

19. The computer-readable medium of claim 14, wherein deleting periodically the other ones of the plurality of content data instances comprises deleting periodically the other ones of the plurality of content data instances based on a play-back probability tending towards a predetermined decay curve.

20. The computer-readable medium of claim 14, further comprising refusing play-back requests when an insufficient number of copies remain in the plurality of content data instances.
